(19) United States
(12) Patent Application Publication
(10) Pub. No.: US 2003/0209862 A1
(43) Pub. Date: Nov. 13, 2003

(54) Metal end cap seal with annular protrusions

(75) Inventors: Kendall E. Keene, Houston, TX (US); Danny Kay Wolff, Houston, TX (US); Roman Czyrek, Houston, TX (US)

Correspondence Address: CONLEY ROSE, P.C., P. O. BOX 3267, HOUSTON, TX, 77253-3267, US

(73) Assignee: Cooper Cameron Corporation, Houston, TX

(21) Appl. No.: 10/143,418

(22) Filed: May 10, 2002

(51) Int. Cl. F16L 5/02

(52) U.S. Cl. 277/607

(57) ABSTRACT

The present invention relates to a metal end cap seal for a well sealing assembly for sealing the annulus between two tubular members that has improved sealing abilities at an increased range of temperatures. The metal end cap seal generally comprises a resilient ring with a metal end caps on either end. The inner diameter of the resilient ring has one or more annular protrusions along the inside diameter of the resilient ring. The annular protrusions are sized so as to provide additional interference with the internal tubular member and provide areas of localized compressive stress within the resilient ring while maintaining a desirable overall stress distribution.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates generally to seals, and more particularly to well sealing assemblies that seal off an annulus between two tubular members, especially in wellhead tubing hanger applications. Still more particularly, the present invention relates to metal end cap seal assemblies generally comprising a resilient seal ring with metallic caps affixed to either end of the seal ring.

A hydrocarbon well is normally produced through a tubing string rather than through the casing that lines the wellbore. A well will often have several strings of tubing through which production operations can be supported. Because each string of tubing is often used independently of adjacent strings, the annulus between adjacent, concentric strings of tubing must be reliably sealed. These seals must be able to withstand high pressures, corrosive environments, and a wide range of temperatures. It is also desirable to have a sealing mechanism that will maintain a seal without a continuous compressive load, which allows for simplification of the sealing mechanism as well as the setting and retrieving procedures.

One such sealing mechanism is disclosed in U.S. Pat. No. 4,496,162, issued to McEver et al., and incorporated herein by reference for all purposes. A simplified sealing mechanism, as is well known in the is shown in FIG. 1. Sealing assembly 10 is disposed within a housing 12 and is shown in an unset position. Housing 12 has a tapered surface 28 and a sealing surface 29. Sealing assembly 10 generally includes tubular body 18 having an outer surface 26, back-up ring 32, setting sleeve 38, and metal end cap seal 36. Back-up ring 32 releasably connects to surface 26 by shear pin 34 and is positioned below seal 36. Setting sleeve 38 is disposed above seal 36. Metal end cap seal 36 generally comprises a resilient ring 58 with metallic caps 50, 52 disposed on the top and bottom of ring 58.

Now referring to FIG. 2, the sealing assembly 10 is shown in a set position. Setting sleeve 38 has been moved downward, shearing pin 34 and moving metal end cap seal 36 into a position between housing sealing surface 29 and surface 26. In the set position, resilient ring 58 is compressed between body 18 and housing 12 creating a force on legs 56 of end caps 50, 52, that pushes legs 56 outward toward their related sealing surfaces and creates metal-to-metal seals between end caps 50 and 52 and the sealing surfaces of housing 12 and body 18. By having an energized elastomeric seal effectively protected by metal-to-metal seals, this sealing arrangement avoids extrusion of the resilient ring and protects the resilient ring from exposure to wellbore fluids.

Sealing assemblies utilizing metal end cap seals, such as that described above, have found widespread use in tubing hanger applications in a variety of operating conditions by providing seal assemblies that can be easily energized, avoid seal extrusion, and can be easily retrieved. Wells today are being drilled in increasingly harsh environments and the conditions in which these sealing assemblies have to perform is constantly evolving. One area in which the performance of metal end cap seal rings has been problematic is in low temperature applications where energization of the resilient material becomes difficult due to reduced temperatures or other environmental effects.

The present invention is directed to improved methods and apparatus for metal end cap seal rings that seek to overcome these and other limitations of the prior art. In particular the present invention is directed to providing an improved metal end cap seal design that is more easily energized at low temperatures.

### SUMMARY OF THE PREFFERED EMBODIMENTS

Accordingly, there is provided herein a metal end cap seal assembly for sealing the annulus between two concentric tubular members that provides improved sealing performance at a wide range of temperatures. A metal end cap seal generally comprises a resilient ring with a metal end caps on either end wherein the inner diameter of the resilient ring has a plurality of annular protrusions that reduce the inner diameter at localized regions. The annular protrusions form circumferential ribs along the inside diameter of the seal. The ribs may have a triangular, semi-circular, or other shaped cross-section.

The annular protrusions provide additional interference between the seal and the inner tubular thereby creating regions of high compression in the body of the seal. The additional compression causes localized stress concentrations, while maintaining a desirable overall stress level through the resilient ring. This stress distribution enhances the performance of the sealing assembly, especially in low temperature applications.

Thus, the present invention comprises a combination of features and advantages that enable it to substantially advance metal end cap seal art by providing apparatus for increasing the range of temperature performance. These and various other characteristics and advantages of the present invention will be readily apparent to those skilled in the art upon reading the following detailed description of the preferred embodiments of the invention and by referring to the accompanying drawings.

### BRIEF DESCRIPTION OF THE DRAWINGS

For a more detailed understanding of the preferred embodiments, reference is made to the accompanying Figures, wherein:

FIG. 1 is a partial sectional view of a sealing assembly in the unset position;

FIG. 2 is a partial sectional view of a sealing assembly in the set position;

FIG. 3 is a partial sectional view of one embodiment of a metal end cap seal;

FIG. 4 is an enlarged partial sectional view of the metal end cap seal of FIG. 3, shown in the set position; and

FIG. 5 is a partial sectional view of an alternative embodiment of a metal end cap seal.

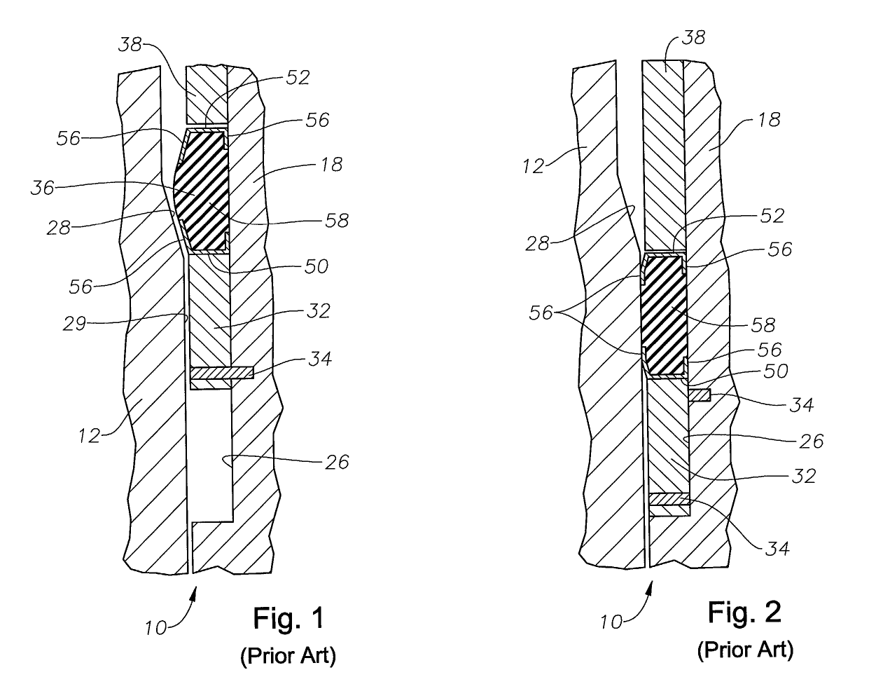

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of certain elements may be omitted in the interest of clarity and conciseness.

The present invention relates to methods and apparatus for providing an annular seal between concentric tubular members. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

In particular, various embodiments of the present invention are described as being used in oilfield applications, in particular as a tubing hangar seals, but the use of the present invention is not limited to either tubing hangars or oilfield applications and may used in any applicable sealing arrangement. Additionally, although the preferred embodiments are described with certain features appearing on either the inside or outside diameter of the seal, it is understood that these features can be used on either diameter in any combination as may be appropriate for a given application. It is to be fully recognized that the different teachings of the embodiments discussed below may be employed separately or in any suitable combination to produce desired results.

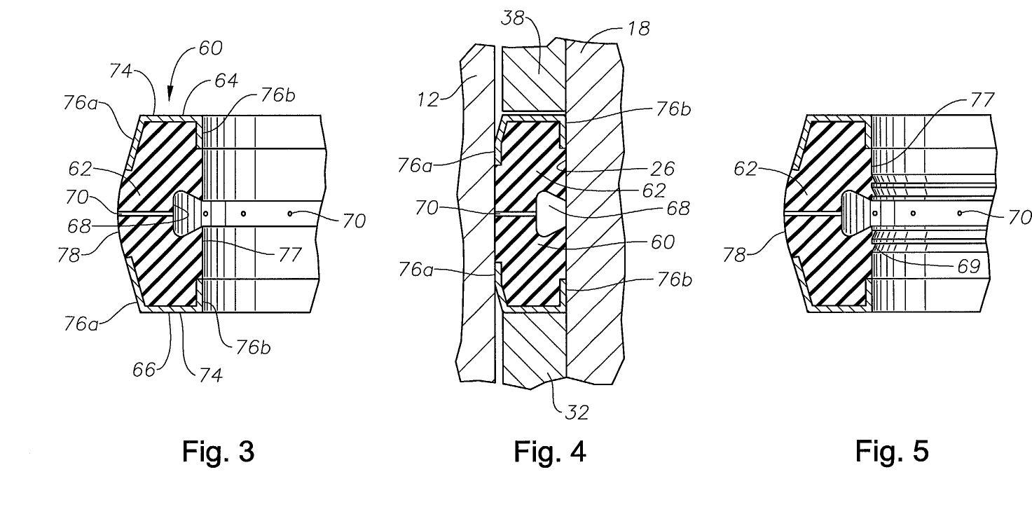

Referring now to FIG. 3, a partial cross-section of one embodiment of a metal end cap seal assembly 60 is shown in an as-constructed configuration. Metal end cap seal assembly 60 includes a resilient ring 62 having metal end caps 64 and 66 preferably bonded to its upper and lower ends. End caps 64 and 66 have a central portion 74 with inner legs 76b and outer legs 76a extending in a direction toward the mid point of resilient ring 62. Outer, central portion 78 of resilient ring 62 is convex shaped, while inner, central portion 77 of resilient ring 62 is generally flat and has one or more annular protrusions 70 located thereon. It is preferred that resilient ring 62 be made of an elastomeric material, such as a nitrile rubber, and metal end caps be constructed from a type 316 stainless steel.

Inner portion 77 preferably has one or more annular protrusions 70 that extend the material of resilient ring 62 past inner legs 76b toward the center of the seal. Protrusions 70 are preferably triangular in cross-section and extend circumferentially around the inner diameter of the resilient ring 62 and 70. Protrusions 70 are oriented so that shallow sloping side 71 is oriented away from the mid-plane of resilient ring 62.

Metal end cap assembly 60 is shown in a set position in FIG. 4. Metal end cap seal assembly 60 is shown in relationship with setting sleeve 38 and back-up ring 32 forming a seal between the housing 12 and surface 26 of body 18. Resilient ring 62 is energized by being compressed between housing 12 and body 18. Metal end caps 64 and 66 are expanded and pushed against housing 12 and body 18 by energized resilient ring 62. Metal-to-metal seals are created between the legs 76a, 76b and the sealing surfaces of housing 12 and body 18. Protrusions 70 are compressed against surface 26 to form localized stress concentrations along the inner edge of resilient ring 62.

Protrusions 70 are preferably triangular in shape but may also be semicircular, rectangular, or other shape. FIG. 5 shows a metal end cap seal 61 with annular protrusions 80 as semicircular cross-sectioned ribs. Regardless of the cross-sectional shape, the protrusions are sized to as to create a localized stress concentration when the seal is set but also allowing for ease of installation of the seal. The protrusions are also preferably sized so as to maintain an overall stress in the resilient ring that will enable long seal life. The annular protrusions formed as a series of ribs provides advantages over having the inner diameter as a whole decreased, in that the ribs allow high localized stress concentrations while maintaining a desirable overall stress condition for the seal.

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. A seal assembly comprising:
a resilient ring having a generally flat first side surface, a convex second side surface, an upper surface, and a lower surface;
one or more circumferential protrusions on the first side surface of ring;
a first annular end cap bonded to the upper surface of said resilient ring and having a first leg along a portion of the first side surface and second leg along a portion of the second side surface; and
a second annular end cap bonded to the lower surface of said resilient ring and having a first leg along a portion of the first side surface and second leg along a portion of the second side surface.

2. The assembly of claim 1 where the first side surface is the outer surface of said resilient ring.

3. The assembly of claim 2 wherein said circumferential protrusions are triangular in cross-section.

4. The assembly of claim 2 wherein said circumferential protrusions are semicircular in cross-section.

5. The assembly of claim 1 where the first side surface is the inner surface of said resilient ring.

6. The assembly of claim 5 wherein said circumferential protrusions are triangular in cross-section.

7. The assembly of claim 5 wherein said circumferential protrusions are semicircular in cross-section.

8. A method of increasing the available energy stored within a metal end cap seal having a resilient ring and metal end caps, when the metal end cap seal is compressed between and inner surface and an outer surface, by forming the resilient ring with one or more circumferential protrusions on a first side surface and a convex second side surface so that the seal will have increased diametrical interference with the inner surface when the seal is energized.

9. The method of claim 8 wherein the circumferential protrusions are triangular in cross-section.

10. The assembly of claim 8 wherein said circumferential protrusions are semicircular in cross-section.
